(19) United States
(12) Patent Application Publication
(10) Pub. No.: US 2024/0003849 A1
(43) Pub. Date: Jan. 4, 2024

(54) METHOD FOR INSPECTING PIPELINES AND ASSOCIATED INSPECTION DEVICE

(71) Applicant: ROSEN SWISS AG, Stans (CH)

(72) Inventors: Gunnar Brink, Karlsruhe (DE); Patrik Rosen, Meppen (DE)

(21) Appl. No.: 18/250,579

(22) PCT Filed: Oct. 25, 2021
(86) PCT No.: PCT/EP2021/079562

§ 371 Date: Apr. 26, 2023

(30) Foreign Application Priority Data
Oct. 26, 2020 (BE) BE2020/5750

(51) Int. Cl. G01N 27/87; F16L 55/48

(52) U.S. Cl. CPC G01N 27/87; F16L 55/48; F16L 2101/30

(57) ABSTRACT

A method is provided for inspecting pipelines, in particular pipelines carrying oil, gas or water. A wall of the pipeline is magnetized by a magnetizing apparatus of a first apparatus formed as a pig. A magnetization present in the pipeline wall is used and/or measured as residual magnetization by a second apparatus, which is separate from the first apparatus and formed as an inspection apparatus, in particular at a later time, for inspection purposes. An associated inspection apparatus is also provided.

### CROSS REFERENCE

This application claims priority to PCT Application No. PCT/EP2021/079562, filed Oct. 25, 2021, which itself claims priority to Belgian Application No. BE2020/5750, filed Oct. 26, 2020, the entireties of both of which are hereby incorporated by reference.

### FIELD OF THE INVENTION

The present invention relates to a method for inspecting pipelines, in particular pipelines carrying oil, gas or water, a wall of the pipeline being magnetized by a magnetizing apparatus of a first apparatus formed as a pig. Furthermore, the invention relates to an inspection apparatus with which data concerning defects in the form of cracks, corrosion or delamination are recorded or an inspection of the course of the pipeline is made possible. Inspection is also referred to as a process commonly understood as screening, in which a relative comparison to the previous measurement takes place and in which changes compared to previous measurements are looked at. Here, many measurements are made with a small time interval, whereas in a widely full-blown inspection, absolute values are provided as a result. Both are covered by the subject matter of the present invention.

### BACKGROUND OF THE INVENTION

Conventional inspection apparatuses generate a magnetic field in the pipeline by means of entrained permanent and/or electromagnets and are correspondingly large and heavy. This increases the friction within the pipeline. The more complex the internal geometry of the pipeline due to changes in the free cross-section or due to outgoing installations, the higher the demands on the pig, which often has to traverse pipelines hundreds of kilometers long. A stuck inspection apparatus or pig in a subsea pipeline can have serious consequences for the operation of the pipeline.

Furthermore, it is known from WO 90/00259 to investigate the position of a pig in a pipeline and thus its course on the basis of electromagnetic fields generated by the pig.

### BRIEF SUMMARY OF THE INVENTION

It is therefore the object of the present invention to provide a method and an apparatus with which, in particular, pipelines that are difficult to inspect can be inspected in an improved manner.

In the method according to the invention, a magnetization present in the pipeline wall as residual magnetization is used and/or measured for inspection purposes, in particular at a later time, by a second apparatus which is separate from the first apparatus and is formed as an inspection apparatus. The apparatus formed as an inspection apparatus is thus used separately from the magnetizing apparatus and without the disadvantages associated with a magnetizing apparatus in terms of size and weight, in particular at a later time for inspection of the pipeline. Because the inspection apparatus is now of lighter construction, inspection is simplified. Longer pipelines and pipelines that are more difficult to inspect can be inspected.

The residual magnetization or remanent magnetization present in the pipeline wall may have resulted from a magnetization or inspection run that took place weeks or months earlier. Alternatively, the magnetization may have been generated by a magnetizing apparatus that was moved through the pipeline a few hours or days before the actual inspection process and magnetized its wall. The resulting marking of the pipeline by the magnetizing apparatus is then measured separately in time by another apparatus, which is not coupled to the magnetizing apparatus, in the form of the then still existing remanent magnetic field. The first apparatus can be a conventional inspection apparatus, alternatively it can be a pig which is only provided for magnetization and thus in particular does not record inspection data in the form of, in particular, MFL, EMAT, and/or EC data. Remanent magnetization is not understood to mean the magnetization of the same pipes that may have been impressed during the manufacturing process of the pipes used, but rather a magnetization specifically introduced by a magnetizing apparatus after the pipes have been laid and before a separate inspection process.

Preferably, the magnetizing apparatus will premagnetize the wall of the pipeline by means of a permanent magnet with a magnetic flux density of 1.0 to 2 T, preferably of 1.2 to 1.8 T. The remanent magnetization of the pipeline can then be up to 0.5 T in a subsequent inspection process, which may be sufficient for measurement purposes. In particular, however, the inspection apparatus can also measure significantly smaller magnetic fields. In particular, the measurement will be in a range between 1 nT and 0.5 T, and therefore the inspection apparatus may have correspondingly highly sensitive magnetometers.

In addition, the inspection apparatus can also be designed to not only measure the residual magnetization present in the pipeline wall but also to use it for measurement purposes, for example by using the residual magnetization to generate sound waves generated by means of electromagnetic-acoustic transducers.

The fact that the magnetizing apparatus and the inspection apparatus are spatially separated, i.e. not coupled, and in particular operate staggered in time relative to each other, means that the inspection apparatus can be built much lighter and can be better driven through so-called “challenging pipelines” with more difficult geometries due to large diameter changes, since the entire construction can be designed more flexibly due to the lower weight. With the second pig, a magnetizing apparatus for the primary magnetization of the pipeline under consideration, which is fundamental for a measurement, can be spared. The advantage of the more flexible design applies to inspection apparatuses moving both inside and outside the pipeline. In the present case, staggered in time means in particular that the second pig has a time interval of at least 5 minutes from the first pig.

In particular, the remanent magnetic field or the residual magnetization used for the inspection with the inspection apparatus can be used or measured particularly well if the magnetizing apparatus has changed, in particular reversed, the polarity of a remanent previous magnetic field already present in the wall of the pipeline before the inspection apparatus is used. The residual magnetization used or measured by the inspection apparatus then results from at least two previous runs with at least one magnetizing apparatus. During these runs, the same or an identically constructed pig with a magnetizing apparatus may have been moved through the pipeline. Although already performing magnetizing runs with a magnetizing apparatus of identical polarity is advantageous, changing the polarity makes the magnetic field to be considered even more pronounced.

If the previous, first magnetization of the pipeline was generated by an identically acting magnetizing apparatus, this is guided through the pipeline for the then subsequent and pre-inspection second run of the pig with magnetizing apparatus with reversed polarity, i.e. rotated, for example, with respect to a start and end of the magnetizing apparatus. Alternatively, it can also be a further magnetizing apparatus which generates a magnetic field of correspondingly oriented polarity.

According to a development of the invention, after a first inspection operation of the inspection apparatus and before a second inspection operation, the direction of magnetization of the wall of the pipeline is changed again, so that the pipeline is traversed by a magnetizing apparatus a total of two or three times, the polarities of the magnetizing apparatus and correspondingly the orientation of the magnetic field in the wall of the pipeline changing as a result. This is particularly advantageous for determining volumetric defects and local changes in material properties (so-called “hard spots”), which can be determined by comparing the data from the two inspection runs.

The object set out at the outset is also achieved by a method for inspecting pipelines, in particular pipelines carrying oil, gas or water, a wall of the pipeline being magnetized and the magnetization caused in the wall of the pipeline by the earth's magnetic field being used and/or measured for inspection purposes by an apparatus formed as an inspection apparatus. The inspection purposes correspond to the aforementioned inspection purposes, such as the detection of defects in the form of cracks, corrosion or delamination and, when using high-performance magnetometers, also the tracking of a course of the pipeline.

By separating premagnetization or eliminating the need for premagnetization by a magnetizing apparatus and using the magnetization provided by the earth's magnetic field, the inspection apparatus can also be made much simpler and lighter in this case, allowing the possibility of inspecting pipelines that are otherwise difficult to inspect.

Preferably, before magnetization of the wall of the pipeline, any remanent or natural magnetization present in the wall is measured to determine if an additional run of a pig with a magnetizing apparatus is needed.

In particular, the residual magnetization in the pipeline wall or the remanent magnetization is used to record magnetic flux leakage data (MFL data). MFL data can be used in particular to detect defects in the form of corrosion and/or corrosion cracks. Pittings, i.e. small holes in the wall of the pipeline due to corrosion, can also be detected.

Alternatively, the inspection apparatus, which in this case may have its own, smaller magnetizing unit, can be used to generate EMAT data in the pipeline wall based on an interaction of the magnetic field previously generated by the magnetizing apparatus with an induced magnetic field. Inspection apparatuses based on EMAT technology also build more easily by eliminating the need for a separate magnetizing apparatus to pre-magnetize the pipeline wall.

In particular, however, the inspection apparatus is provided for inspecting the pipeline without a magnetizing apparatus arranged in the region of the sensor for (pre)magnetizing the pipeline wall.

To determine the magnetic field strength by means of the inspection apparatus, the latter has an especially highly sensitive magnetic field sensor. This may be constituted by coils, Hall elements, AMR, GMR, fluxgate, squid and/or similar sensitive sensors or magnetometers. Alternatively or additionally, the inspection apparatus may have proton magnetometers or pumped magnetometers.

Due to the lightweight design of the inspection apparatus when no magnetizing apparatus is used, the inspection apparatus located inside the pipeline can be moved through the pipeline at a distance from the inside of the wall of the pipeline so that friction effects are minimized. Alternatively, the inspection apparatus can be formed as a foam pig and/or as a cup/disc-based pig with reduced frictional resistance on the inside of the pipeline compared to conventional inspection apparatuses. In particular, preferably when an inspection apparatus is formed as an inspection pig floating in the pipeline medium, the inspection apparatus comprises at least one ultrasonic sensor for detecting the position of the inspection apparatus in the pipeline. The position detection is further improved if two ultrasonic sensors or ultrasonic sensor groups arranged offset to each other in the longitudinal direction of the inspection apparatus are present, preferably at the beginning and end of the inspection apparatus for better definition of the position of the pig in the pipeline.

In particular, the inspection apparatus measures the magnetic field in the circumferential direction by means of at least one sensor ring in order to obtain a complete image of the pipeline wall in the circumferential direction for an inspection. Particularly preferably, the inspection apparatus can measure the magnetic field strength of the wall by means of two sensor rings, the sensors of which are located at different distances from a longitudinal center axis of the inspection apparatus, preferably one of the sensor rings being located in the other. By means of these sensor rings, a radial gradient of the magnetic field in wall of the pipeline can be measured with respect to its longitudinal extent. This is particularly advantageous in the event that a magnetic field in the pipeline is simulated in the evaluation on the basis of an assumed grid geometry that maps the pipeline wall.

According to a development of the invention, the inspection apparatus located outside the pipeline can pick up information for determining the position of the pipeline by the magnetization of the wall and/or can follow the course of the pipeline by this magnetization. Here, the inspection apparatus can follow the then still comparatively strong magnetic field, especially in the case of subsea pipelines, during the magnetization of the latter or shortly thereafter, or can follow a remanent magnetic field, which can still have a magnetic flux density of up to 0.5 T in the case of a previous magnetization by a magnetizing apparatus. Offshore and in rivers, pipelines are usually buried up to 1.5 m deep, where sea currents and sediment movements may expose the pipeline, additionally cover it, and move it laterally or horizontally. By tracking the pipeline according to the invention on the basis of its magnetization, it is possible to dispense with the use of so-called “sub-bottom profilers”, which require a great deal of power for use in underwater areas.

According to a development of the invention, a voltage measurement is carried out to determine the condition of a cathodic protection of the pipeline, with errors caused by the inspection apparatus moved relative to the pipeline due to additionally generated voltages being taken into account by determining the magnetic field present in the wall of the pipeline. In order to determine the condition of the cathodic protection of a pipeline and, in particular, of a pipeline laid in water, external electrodes are used to measure either the electric field profile in the water or the voltage between the anode and the cathode (i.e. the pipeline). However, the movement of the inspection apparatus relative to the magnetized pipeline creates voltages that can distort the electrical measurement. By accurate knowledge of the magnetization performed deliberately and precisely in advance, the magnetic field applied to the outside of the pipeline is more precisely defined, so that the unwanted voltages caused by the movement of the inspection apparatus can be better compensated.

The object stated at the outset is also solved as described above and below by an inspection apparatus for carrying out a corresponding measuring method, this inspection apparatus being equipped without its own magnetizing apparatus, in particular for premagnetizing the pipeline, at least with regard to the part of the inspection apparatus using or measuring the remanent magnetization, preferably with regard to the entire inspection apparatus. In particular, the inspection apparatus is formed as a pig for recording MFL data.

Preferably, the sensor and/or the sensor carrier or the sensor rings are magnetless in such a way that permanent magnets or electromagnets are spared. The magnetizing apparatus is only an apparatus for magnetizing the pipeline wall and does not include apparatuses for generating, for example, eddy currents in the pipeline wall or high-frequency electromagnetic fields that interact with a magnetic field already present in the pipeline wall.

In the case of inspection of the pipeline by the inspection apparatus moving in the pipeline, the inspection apparatus is an inspection pig.

For an inspection apparatus that is subsea and follows the pipeline, it is in particular an apparatus formed as an ROV (Remotely Operated Vehicle), especially an ROTV (Remotely Operated Towed Vehicle) or an AUV (Autonomous Underwater Vehicle).

Lastly, the object stated at the outset is also achieved by an arrangement comprising a pig with a magnetizing apparatus and, in particular, without sensors for recording MFL, EMAT, EC and/or other magnetic field data and comprising an inspection apparatus described above or below, the pig and the inspection apparatus being able to travel or move along identical points of a pipeline in a non-coupled manner and, in particular, spaced apart in time as described above or below. Such an arrangement leads by the separation of magnetization and recording of the inspection data, i.e. by the distribution of the tasks accompanying an inspection to separate, non-coupled apparatuses, to the improved inspection of the so-called “challenging pipelines” described above.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 shows a magnetizing apparatus.

FIG. 2 shows another magnetizing apparatus and an inspection apparatus in a pipeline.

FIG. 3 shows a magnetizing apparatus according to FIG. 1 and another inspection apparatus in a pipeline.

FIG. 4 shows a further embodiment of an article according to the invention.

### DETAILED DESCRIPTION OF THE DRAWINGS

Individual technical features of the exemplary embodiments described below can also be combined with exemplary embodiments described above and with the features of the independent claims and, where appropriate, further claims to form articles according to the invention. Where expedient, functionally equivalent elements are provided with identical reference signs.

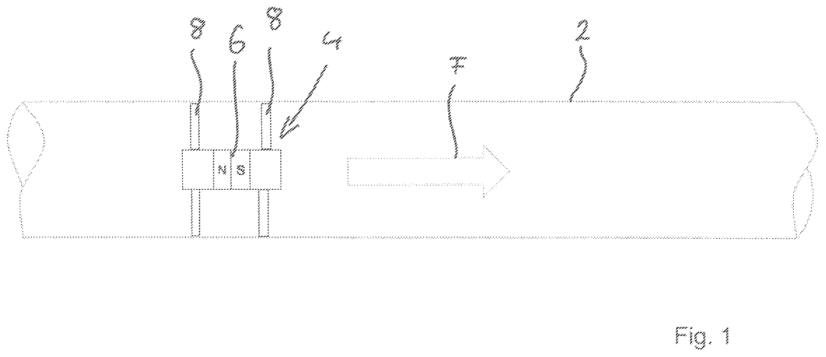

After a first measurement, not shown, of the magnetization of a wall 2 of a pipeline, a pig 4 with a magnetizing apparatus for magnetizing the pipeline wall is guided through the pipeline in the direction of travel F. Such a pig 4 comprises, in accordance with the embodiment shown in FIG. 1, a permanent magnet 6 as magnetizing apparatus, which furthermore has ring brushes 8 for producing a magnetic circuit with the pipeline and thereby effecting magnetization of the pipeline wall.

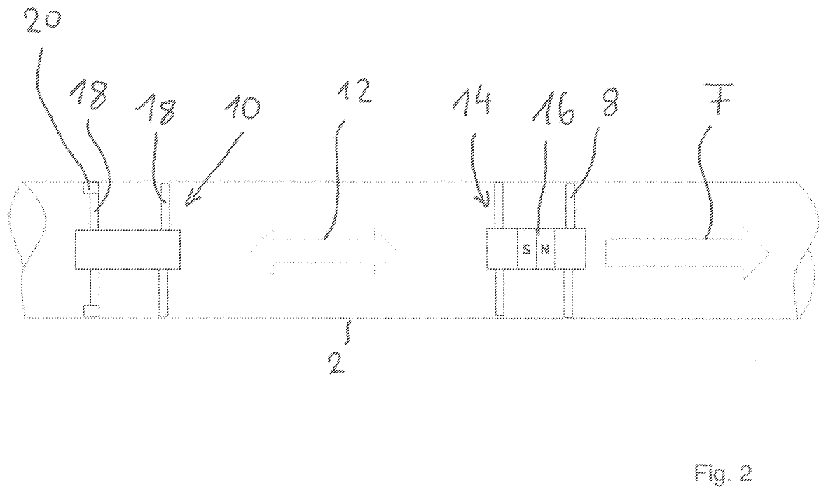

To improve the remanent magnetic field for a subsequent measurement with an inspection apparatus 10 (FIG. 2), which is moved through the pipeline at a distance, indicated by a double arrow 12, of at least 100 meters behind a pig 14 with a further magnetizing apparatus, the magnetic field already introduced into the pipeline by the pig 4 according to FIG. 1 is now rotated with respect to its polarity by the orientation of a permanent magnet 16 rotated with respect to the direction of travel F, indicated by poles S and N now arranged differently from one another. In addition to the two ring brushes 8 of the pigs 4 and 14 in each case, these can have means serving for propulsion in the form of conventional cups, for example.

The inspection apparatus 10 is formed as an inspection pig and has front and rear pig plates 18 in the form of cups or discs, with magnetic field sensors 20 being arranged on the pig discs at the rear in the direction of travel, which sensors are highly sensitive and are equipped either as a sensor ring with a large number of sensors, for example at least 6 sensors, or for screening of the pipeline with only a few sensors (at least one sensor) in the circumferential direction.

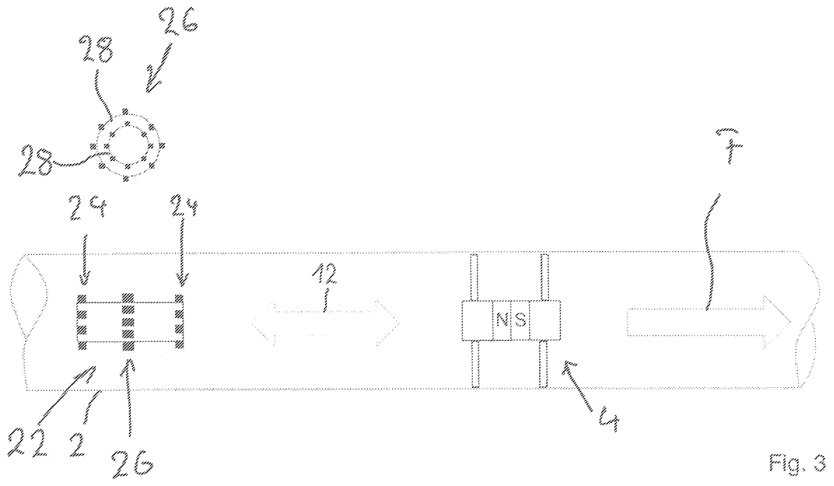

According to an alternative embodiment of the method according to the invention and with alternatively formed apparatuses, a second premagnetization of the pipeline with sensors in the reversed direction by the magnetizing apparatus 14 according to FIG. 2 is spared and only a pig 4 is moved through the pipeline in the direction of movement F of the medium therein (FIG. 3). This magnetizing apparatus is followed at a suitable distance 12 by an inspection apparatus 22, which does not touch the pipeline wall 2, in the form of a pig which floats freely in the pipeline and has an ultrasonic sensor ring 24 at the front and rear in the direction of movement F, via which the position of the pig in the pipeline can be determined. The pig with magnetizing apparatus 14 and the apparatus 22 formed as an inspection pig represent an arrangement according to the invention.

A sensor apparatus 26 is arranged in the center of the inspection apparatus 22 and has two sensor rings 28 arranged one inside the other with MFL sensors or magnetometers and is shown additionally above the pipeline for illustration purposes. This sensor arrangement is used to capture MFL data both in the circumferential direction and in the radial direction with respect to a longitudinal axis of the inspection apparatus running in the longitudinal direction of the pipeline.

In addition, an inspection apparatus moving in the pipeline 2 according to FIG. 2 can be equipped with an odometer and/or can have an MES gyrometer on board. This serves to determine the position of the inspection apparatus in the pipeline later.

Overall, the inspection apparatuses according to the invention allow significantly better passage characteristics through the pipelines, so that even so-called “challenging pipelines”, which are characterized by geometric complexity such as diameter changes, bends and installations, can be inspected more effectively.

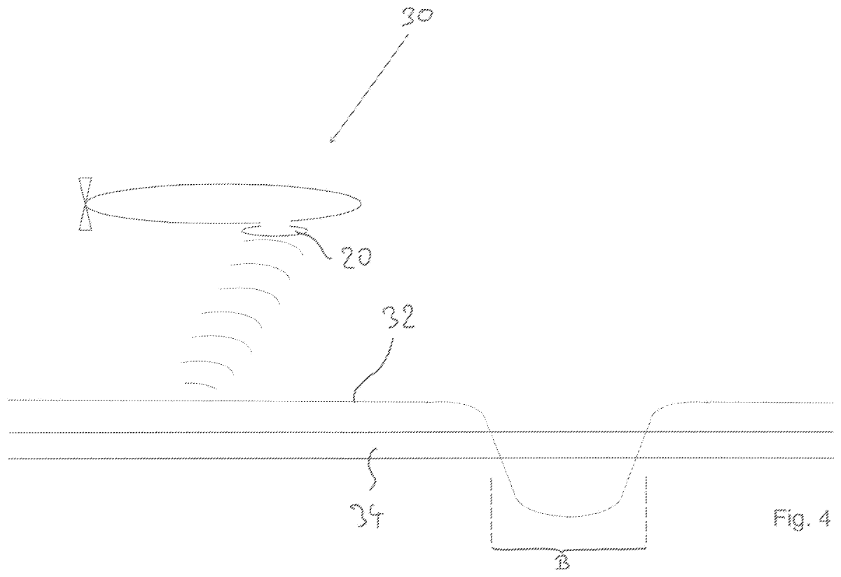

According to another embodiment of the invention, an inspection apparatus 30, in the form of an ROV, which has a highly sensitive magnetic field sensor 20 streamlined on its underside, follows the course of a pipeline 32 laid underwater, which partially rests on a sediment 34, but is covered by the sediment 34 in a region B (FIG. 4). Alternatively, the magnetic field sensor might not be installed under an ROV but carried, for example, over any handles that may be present, in order to examine individual areas in greater detail. This measurement method also makes it possible to find buried pipelines, and to follow their course, with the help of the magnetic field in their walls.

1. A method for inspecting pipelines, the method comprising the steps of:
magnetizing a wall of the pipeline by a magnetizing apparatus of a first apparatus formed as a pig,
using and/or measuring a magnetization present in the pipeline wall for inspection purposes by a second apparatus which is separate from the first apparatus and is formed as an inspection apparatus.

2. The method as claimed in claim 1, wherein the magnetizing apparatus has changed, the polarity of a remanent previous magnetic field already present in the wall of the pipeline in time and/or location before the inspection apparatus is used.

3. The method as claimed in claim 1, wherein after a first inspection operation of the inspection apparatus and before a second inspection operation, a direction of magnetization of the wall of the pipeline is changed again.

4. A method for inspecting pipelines, a wall of the pipeline being magnetized at least in part by the earths magnetic field, the method comprising the steps of:
using and/or measuring magnetization in the wall of the pipeline for inspection purposes by an apparatus formed as an inspection apparatus.

5. The method as claimed in claim 1, wherein, before magnetization of the wall of the pipeline, any remanent or natural magnetization present in the wall is measured.

6. The method as claimed in claim 5, wherein the inspection apparatus detects the remanent magnetization to obtain MEL data or EMAT data.

7. The method as claimed in claim 1, wherein the inspection apparatus determines the magnetic field strength by at least one magnetic field sensor.

8. The method as claimed in claim 1, wherein the inspection apparatus located inside the pipeline is moved through the pipeline at a distance from the inside of the wall of the pipeline or as a foam pig and/or as a cup/disc-based pig.

9. The method as claimed in claim 1, wherein the inspection apparatus measures the magnetic field in a circumferential direction.

10. The method as claimed in claim 9, wherein the inspection apparatus measures the magnetic field strength of the wall via two sensor rings, the sensors of which are located at different distances from a longitudinal center axis of the inspection apparatus.

11. The method as claimed in claim 1, wherein the inspection apparatus located outside the pipeline picks up information for determining the position of the pipeline by the magnetization of the wall and/or follows the course of the pipeline by the magnetization.

12. The method as claimed in claim 1, wherein a voltage measurement is carried out to determine a condition of a cathodic protection of a pipeline, with errors caused by the inspection apparatus moved relative to the pipeline due to additionally generated voltages being taken into account by determining the magnetic field present in the wall of the pipeline.

13. An inspection apparatus for carrying out a method as claimed in claim 1, wherein at least a part of the inspection apparatus using or measuring the magnetization is formed without its own magnetizing apparatus.

14. An inspection apparatus for carrying out a method as claimed in claim 11, wherein at least a part of the inspection apparatus using or measuring the magnetization is formed without its own magnetizing apparatus, wherein the inspection apparatus is formed as an ROV, or as an AUV.

15. An arrangement comprising:
at least a first apparatus formed as a pig with a magnetizing apparatus, and
an inspection apparatus as claimed in claim 13 which is separate from the first apparatus.

16. The method for inspecting pipelines of claim 1, wherein the step of using and/or measuring the magnetization present in the pipeline wall for inspection purposes occurs at a later time by the second apparatus.

17. The method as claimed in claim 2, wherein the magnetizing apparatus has reversed the polarity of the remanent previous magnetic field already present in the wall of the pipeline in time and/or location before the inspection apparatus is used.

18. The method as claimed in claim 8, wherein at least one ultrasonic sensor being present for detecting the position of the inspection apparatus in the pipeline.

19. The method as claimed in claim 9, wherein the inspection apparatus measures the magnetic field in the circumferential direction by at least one sensor ring.

20. The inspection apparatus of claim 9, wherein the entire inspection apparatus is formed without its own magnetizing apparatus.

21. The arrangement of claim 15 wherein at least the first apparatus formed as the pig with the magnetizing apparatus is formed without sensors for recording MEL, EMAT, EC and/or other magnetic field data.

22. The method as claimed in claim 4, wherein, before magnetization of the wall of the pipeline, any remanent or natural magnetization present in the wall is measured.
